(19) United States
(12) Patent Application Publication
(10) Pub. No.: US 2010/0258011 A1
(43) Pub. Date: Oct. 14, 2010

(54) CLEANING DEVICE WITH SCOURING INTERIOR SURFACE

(75) Inventor: Russell Kahn, Madison, WI (US)

Correspondence Address: FAY SHARPE LLP, 1228 Euclid Avenue, 5th Floor, The Halle Building, Cleveland, OH, 44115, US

(73) Assignee: Synergy Products, LLC.

(21) Appl. No.: 12/420,511

(22) Filed: Apr. 8, 2009

(51) Int. Cl. A47J 19/00; A23N 15/00; A47J 17/02; B01D 29/00

(52) U.S. Cl. 99/451; 15/105; 99/567; 210/251

(57) ABSTRACT

A cleaning device can include a strainer that includes a base including an upper open end and an inner surface having abrasive scouring elements for removing debris from associated articles placed into the strainer. Openings extend through the base to allow liquid to pass through the openings carrying debris away from the associated articles retained in the strainer.

### BACKGROUND

Traditional strainers and colanders are cylindrical in shape and have a porous base that allows liquid to be separated from articles maintained within the strainer or colander. Several variations have been created, such as strainers having shapes other than cylindrical, foldable strainers for more compact storage, and strainers that include attachments like cutting boards and extensions to rest in sinks.

These common types of strainers have been manufactured for many years without improvement to their function. These known strainers do not include a component to facilitate the cleaning of objects placed into the strainer other than the openings in the strainer that allow liquid to flow through the strainer to separate from the articles contained in the strainer.

Some known devices combine a cutting and straining function. A device disclosed in U.S. Pat. No. 4,258,069 includes a complicated machine for removing material from the surface of fruits and vegetables. U.S. Design Pat. No. D433,384 appears to disclose a colander with bumps formed on an interior surface; however, it appears that the colander disclosed in this design patent would not be intuitive to use and would not clean produce as efficiently as the embodiments discussed below.

### SUMMARY

Examples of cleaning devices that overcome the aforementioned shortcomings will be described below. An example of such a cleaning device is a strainer having a base including an upper open end, an inner surface having abrasive scrubbing elements for removing debris from articles placed into the strainer and openings extending through the base for allowing liquid to pass through the openings carrying debris away from the articles retained in the strainer.

An example of another cleaning device that overcomes the aforementioned shortcomings can include a cleaning device including a base having a first surface and a second surface and scouring elements on the first surface. The base can be generally water impervious and generally flat and flexible. The scouring elements can be located on the first surface of the base to define a roughened surface. The roughened surface can include at least about 50 scouring elements per square inch and the scouring elements can have an average diameter of less than about 335 micrometers. Other examples of strainers, colanders and similar cleaning devices will be described in more detail below.

### BRIEF DESCRIPTION OF THE DRAWINGS

FIG. 1 is a perspective view of a cleaning device including strainer having an interior scouring surface and a lid for use with the strainer.

FIG. 2 is a cross-sectional view taken along line 2-2 in FIG. 1.

FIG. 3 is a top plan view of an alternative embodiment of the strainer shown in FIG. 1.

FIG. 4 is top plan view of another alternative embodiment of the strainer shown in FIG. 1.

FIG. 5 is a side cross-sectional view of a cleaning device including a mechanism for moving articles within a strainer having an interior scouring surface.

FIG. 6 is a top plan view of a cleaning device including an alternative embodiment of a mechanism for moving articles found within a strainer.

FIG. 7 is a perspective view of an alternative embodiment of a strainer.

FIG. 8 is a cross-sectional view taken through a wire used to form the strainer shown in FIG. 7.

FIG. 9 is a side cross-sectional view of another embodiment of a cleaning device including a strainer having an interior scouring surface.

FIG. 10 is a perspective view of another alternative embodiment of a cleaning device.

### DETAILED DESCRIPTION

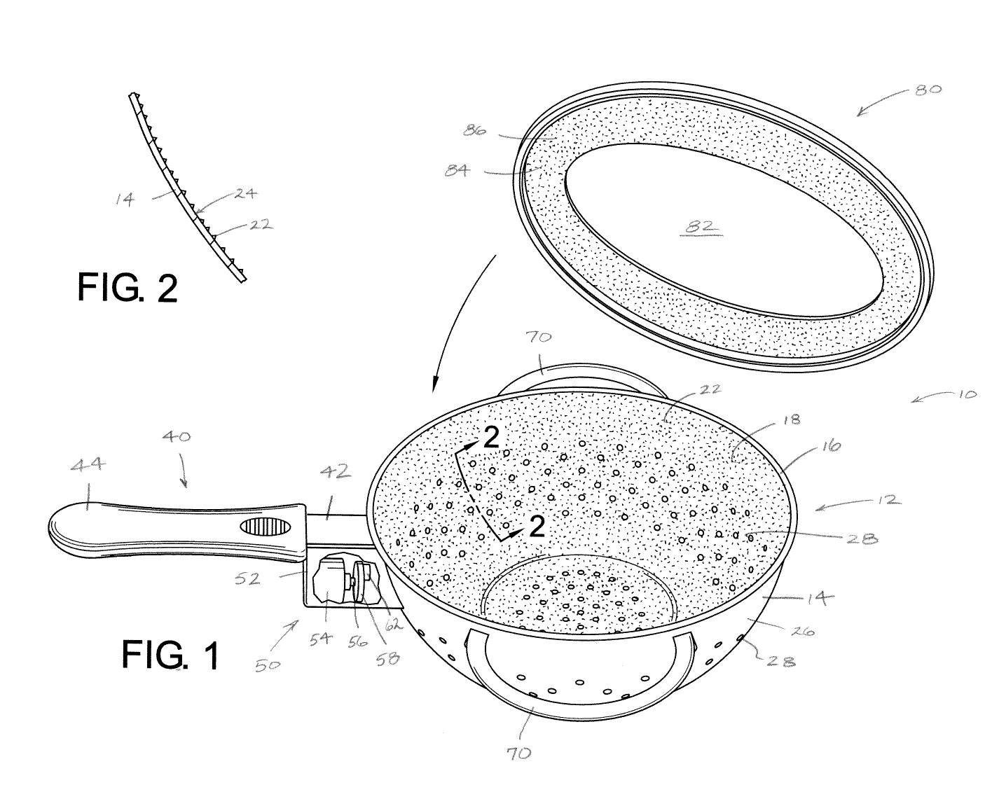

With reference to FIG. 1, a cleaning device 10 is shown which is useful for cleaning food, such as fruits, vegetables, rice and other items. The device shown in FIG. 1, as well as the devices that will be described in more detail below, are also useful in cleaning other articles including machine parts and finished manufactured items that would be cleaned prior to shipping. Even though the devices described below may be described in more detail with reference to cleaning produce and other food, this should not be taken to limit the invention to what articles could be cleaned using the cleaning devices described below.

Produce such as potatoes, carrots, apples, beets and the like are difficult to clean and often require peeling, scraping or brushing the produce. Because peeling the produce removes the nutritional skin, brushing is often found to be a healthier or more desirable choice. Brushing is usually accompanied by running water over the produce and using a hand-held brush to brush the outer skin of the produce. The cleaning devices described below include a scouring feature that makes cleaning produce (and other articles described above) more efficient as compared to known methods.

The cleaning device 10 shown in FIG. 1 includes a strainer 12, or a colander, including a base 14 having an upper open end 16. In the embodiment depicted in FIG. 1, the base 14 is bowl-shaped being substantially hemispherical. The base 14 can take other configurations that would allow for the strainer 12 to retain articles within the base, e.g. rectangular box-shaped, cylindrical, etc. The base 12 can be made from metal or plastic. Additionally, the base 14 could be made from a flexible material such that when articles are deposited into the base, the weight of the articles would result in the shape of the base changing to envelop the articles deposited into the base more so than if the base were made from a more rigid material. A flexible base 14 can also allow the strainer 12 to collapse into a storage position. The size of the base 14 can range from a very large base that can accommodate many articles, e.g., a base height having a diameter greater than about 12 inches to a smaller base that is only a few inches in diameter.

With continued reference to FIG. 1, the base 14 includes an internal surface 18. The internal surface 18 can be referred to as a scrubbing interior surface, since the surface includes a plurality of scouring elements 22 for removing debris from articles placed into the strainer 12. The scouring elements 22 can be protrusions, protuberances and/or bumps (similar to sandpaper) used to clean the skin of produce or clean the exterior surface of articles placed into the strainer. With reference to FIG. 2, the interior surface 18 of the base 14 can include a generally smooth base surface 24 and the protrusions 22 extend upwardly from the base surface.

The protrusions 22 can make the scrubbing interior surface 18 similar to sandpaper. The protrusions 22 can extend a height of about 85 micrometers from the generally smooth base surface 24 to about 640 micrometers from the generally smooth base surface. The protrusions 22 can have an average diameter of about 85 micrometers to about 640 micrometers. Additionally, the interior scrubbing surface 18 can include from about 30 protrusions per square inch to about 425 protrusions per square inch. It is believed that where the average diameter of the protrusions gets too large or the density of the protrusions gets too low (e.g. about 30 protrusions per square inch and an average protrusion diameter of at least about 650 micrometers) that too much friction between the produce and the scrubbing interior surface 18 may result, which would result in the produce not being effectively cleaned. Also, where the protrusions get too large or the density too sparse the skin of the produce may become undesirably damaged during cleaning.

Where the base 14 is made from metal, the protrusions 22 can be deposited onto the generally smooth interior surface 24 using a thermal spray and electric wire arc. Where the base 14 is made from plastic, the base and protrusions 22 can be injection molded to extend upwardly from the smooth interior base surface 24. Alternatively, an insert can be provided that is received in the base 24 that includes the protrusions to provide the scouring surface inside of strainer 12. Also, a coating, e.g. a paint or primer, can be applied onto the base surface 24 where the coating includes particles that can act as the scrubbing elements. This could also be accomplished in a two-step process where the coating is applied and then the particles are added. The shape of the protrusions can take many configurations, e.g., substantial spherical, prismatoid, and/or conical.

With reference back to FIG. 1, the base 14 of a strainer 12 also includes an external surface 26, which can be generally smooth. The base 14 also includes openings 28 that extend through the base, i.e., from the internal surface 18 to the external surface 26. These openings 28 are dimensioned similar to openings found in a conventional strainer and/or colander. The openings allow liquid to pass through carrying debris from the articles remaining in the strainer 12. In the embodiment depicted in FIG. 1, with respect to the upper open end 16, at least some of the openings 28 are located vertically below a respective abrasive protrusion 22. This allows water to easily drain from the strainer without having to turn the strainer upside down (the strainer is shown right-side up in FIG. 1).

With continued reference to FIG. 1, the cleaning device 10 also includes a handle 40 connected with the base 14. For the embodiment depicted in FIG. 1, the handle 40 includes a relatively flat bar 42 that connects with the base 14 and a handgrip 44 connected with and/or formed over the bar 42. The handgrip 44 provides a location for an operator of the cleaning device 10 to grip the strainer 12 while cleaning articles retained within the strainer 12.

Although not required, a vibrating device 50 can be associated with the cleaning device 10. In the embodiment depicted in FIG. 1, the vibrating device 50 connects to the handle 40 and the base 14. The vibrating device 50 includes a housing 52 that contacts the handle (more specifically the bar 42) and the base 14. The housing 52 can connect to the handle 40 and the base 14 in a conventional manner. The vibrating device 50 also includes a motor 54 having an output shaft 56. A hub 58 connects with the output shaft 56 and an off-center weight 62 connects with the hub 58. The off-center weight 62 is off-center from the rotational axis of the output shaft 56 and the hub 58 so that a vibratory motion results when the motor 54 is energized. The motor 54 is energized using a power source (not shown) such as batteries. Other types of vibrating devices can be used with the cleaning device.

With continued reference to FIG. 1, the cleaning device 10 also includes auxiliary handles 70 attached with the base 12. These auxiliary handles in the depicted embodiment are generally C-shaped or U-shaped having terminal ends that connect with the base 14 at the exterior surface 26. These auxiliary handles 70 can allow the strainer 12 to rest on a sink or can be gripped by an operator.

With continued reference to FIG. 1, the cleaning device 10 can include a lid 80 that can cooperate with the strainer 12 to retain articles within the strainer during the cleaning process. The lid 80 is shown fully removable from the strainer 12. In alternative embodiments, the lid 80 can attach to the strainer 12 via a hinge connection. In another alternative embodiment, the lid 80 can be non-removably attached to the strainer 12. The lid 80 could look similar to a flange to provide a smaller cross-sectional opening through which items are placed into the strainer 12 as compared to the greatest cross-sectional area of the strainer 12 below the lid 80.

In the embodiment depicted in FIG. 1, the lid 80 includes an opening 82. In alternative embodiments, such as where the lid is removable from the strainer 12, no opening 82 may be provided. The lid 80 also includes an internal surface 84 that can include scouring elements 86, which are similar to the scouring elements 22 found in the base 14 of the strainer 12. The interior surface 84 of the lid 80 can include the generally smooth base surface similar to the generally smooth base surface 24 found in the base 14 of the strainer 12. The protrusions 86 can be similar in shape and size and density, e.g., protrusions per square inch, as the protrusions 22 described above with respect to the base 14 of the strainer. Also, the protrusions (scouring elements) 86 can be formed on the lid 80 in the same manner that the scouring elements 22 were formed on the strainer 12. Accordingly, further description of the interior surface 84 and protrusions 86 on the lid 80 is not provided.

To operate the device 10 shown in FIG. 1, the operator places articles to be cleaned inside the strainer 12. The articles can be loaded into the strainer 12 with the lid 80 removed from the strainer or through the opening 82 provided in the lid 80 when the lid 80 is attached to the strainer. With the articles placed in the strainer 12, the operator can run water over the articles through the opening 82 and move the strainer 12 so that the articles tumble across the roughened interior surfaces 18 and 84, thus removing debris from the articles. The interior surface 84 of the lid 80 can retain the articles within the strainer 12 and at least substantially preclude these articles from hopping out of the strainer while the operator moves the strainer. If desired, the vibrating device 50 can also be used to promote agitation of the articles within the strainer 12. As debris is being removed from the articles placed into the strainer, water that is running over the articles carries the debris through the openings 28 in the base 14, thus away from the articles retained in the strainer 12. The scrubbing interior surface 18 of the strainer and the scrubbing interior surface 84 of the lid are designed to remove debris from produce (or other articles found in the strainer) while minimizing any damage to the skin of the produce, thus retaining the nutritional benefits of the skin of the produce (or minimizing any scuffing or damage to the external surface of any articles placed within the strainer 12).

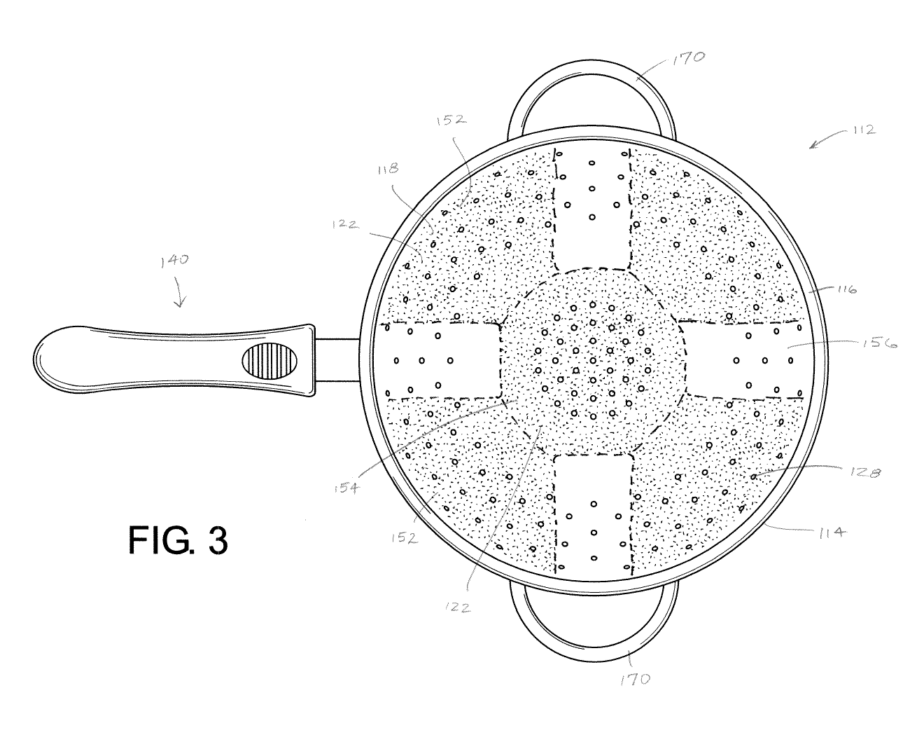

FIG. 3 depicts an alternative embodiment of a strainer 112. The strainer 112 can be used with the lid 80, or a similar lid to provide a cleaning device similar to the device shown in FIG. 1. The strainer 112 includes a base 114 and an upper open end 116 similar to the embodiment shown in FIG. 1. The strainer 112 also includes an internal surface 118, which is different than the embodiment shown in FIG. 1.

The strainer 112 can include first roughened interior surface sections 152 (four are shown), second roughened interior surface sections 154 and smooth interior surface sections 156. The roughened interior surface sections 152 and 154 can be similar to and formed in the same manner as the roughened interior surface 18 described above with respect to FIG. 1, including similarly sized scrubbing elements or protrusions 122 having a similar shape and density to those described above. The smooth interior surface sections 156 are substantially devoid of protrusions 122. Openings 156 can still be provided in these smooth interior surface sections.

A difference between the embodiment depicted in FIG. 3 and the embodiment depicted in FIG. 1 is that the density of the protrusions in the first roughened interior sections 152 can be different than the density of the protrusions in the second roughened interior section 154. The average diameter and/or the height of the protrusions can also differ between the sections 152 and 154.

In the depicted example shown in FIG. 3, the first roughened interior sections 152 are located vertically above the second roughened interior section 154. In the first (upper) roughened interior sections 152, the density of the protrusions can be less than the density of the protrusions in the second (lower) roughened interior section 154 and the average diameter and/or the height at which the protrusions extend from a base surface can be greater in the upper roughened interior sections 152 as compared to the lower roughened interior section 154. Such a configuration can result in lower friction on the produce (objects) moving in the lower section of the strainer 112 and the fewer, yet larger, protrusions in the upper roughened sections 152 can slow down the objects near the upper open end 116 of the strainer to prevent the objects from escaping the strainer while the strainer is moving and cleaning the objects. If desired, each of the roughened sections 152 and 154 can be made to have a different grit factor, e.g. size and density of protrusions. The differing sections can also be different colors.

Similar to the embodiment described in FIG. 1 above, the strainer 112 in FIG. 3 can also include openings 128 that extend through the base 114. The openings allow liquid to pass through carrying debris from the strainer 112. The openings 128 can be of similar size and shape as the openings 28 described above with reference to FIG. 1.

The strainer 112 can also include a handle 140 connected to the base 114 similar to the handle 40 described above. Auxiliary handles 170, similar to the auxiliary handles 70 described above, can also connect with the base 114. If desired, a vibrating device (not shown in FIG. 3) can also be provided with the strainer 112. Operation of the strainer 112 would be similar to the operation of the cleaning device 10 described above with reference to FIG. 1.

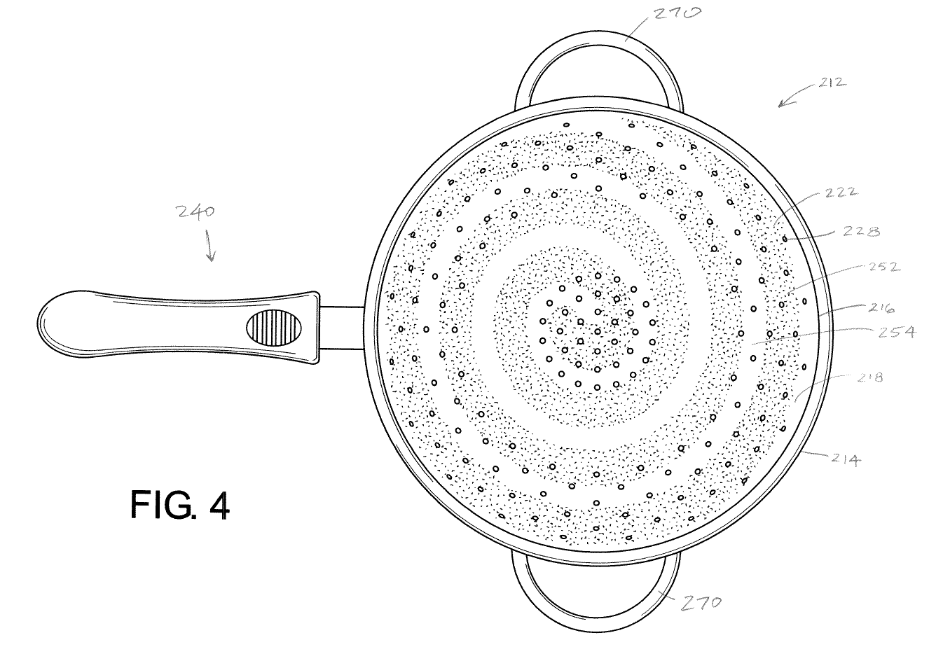

FIG. 4 depicts another alternative embodiment of a strainer 212. Similar to the embodiments described with reference to FIGS. 1 and 3, the strainer 212 includes a base 214 having an upper open end 216. The strainer 212 also includes an internal surface 218. The embodiment depicted in FIG. 4 differs from the embodiments depicted in FIGS. 1 and 3 in that the internal surface 218 includes a roughened interior surface section 252, which includes scrubbing elements or protrusions 222, and a smooth interior surface section 254, which is substantially devoid of protrusions 222. In the embodiment depicted in FIG. 4, the roughened interior surface section 252 can be similar and formed in the same manner as the roughened interior surface 18 described above with reference to FIG. 1 and can include similarly sized and shaped protrusions 222. The density of these protrusions 222 can also be similar to that described above.

In the embodiment depicted in FIG. 4, both the roughened interior section 252 and the smooth interior surface section 254 are generally spiral-shaped. Similar to the embodiment shown in FIG. 3, the smooth interior surface section 254 interrupts the roughened interior section. Similar to the embodiments described above, with respect to the upper open end 216, at least some openings 228, which extend through the base 214, are located vertically below a respective abrasive protrusion 222. FIGS. 3 and 4 depict examples of patterns for the roughened internal surface of the strainer. Other designs and patterns may be used without departing from the scope of the invention.

Similar to the handles 140 and 40 described above, the strainer 212 depicted in FIG. 4 can include a handle 240. Also, the strainer 212 can include handles 270 that are similar to the auxiliary handles 70 and 170 described above.

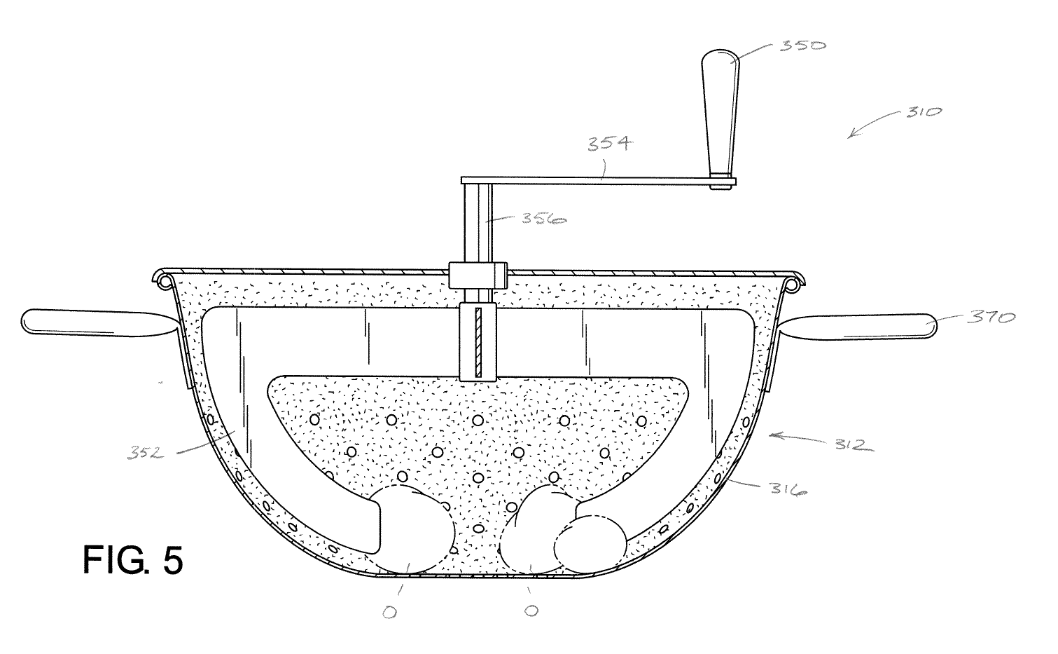

With reference to FIG. 5, an alternative embodiment of a cleaning device 310 is shown. The cleaning device 310 includes a strainer 312 which can be similar to the strainer 12 shown in FIG. 1, the strainer 112 shown in FIG. 3, or the strainer 212 shown in FIG. 4. Accordingly, further description of the strainer 312, which also includes a base 316, will not be provided. The cleaning device 310 also includes fixed handles 370, which are similar to the handles 70 described above with reference to FIG. 1.

The cleaning device 310 depicted in FIG. 5 also includes a handle 350 that is movable with respect to the strainer 312. Paddles 352 are operatively connected with the handle 350. Movement of the handle 350 results in movement of the paddles 352. More particular to the embodiment described in FIG. 5, the handle 350 connects to a crank arm 354, which is connected to a rotatable axle 356. The paddles 352 are connected fast with the axle 356. Rotation of the axle 356 results in rotational movement of the paddles 352 about the rotational axis of the axle 356. An operator cranks the handle 350 about the axle 356 moving the paddles 352 to move objects O placed in the strainer 312; therefore, cleaning the objects inside. In addition to being manually operated, the paddles 352 can be driven by a motor (not shown) connected with a power source (e.g. batteries, also not shown).

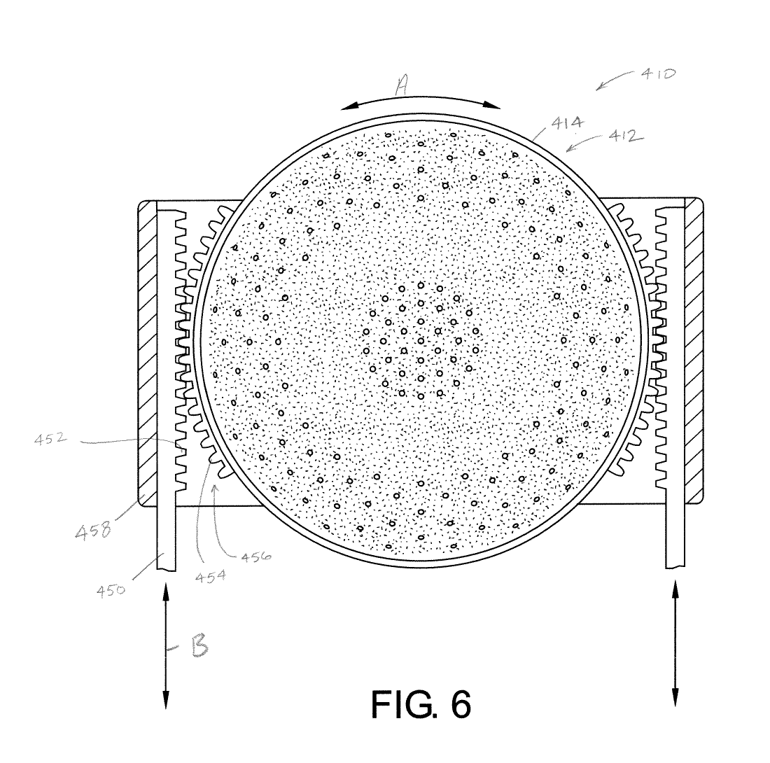

FIG. 6 depicts an alternative embodiment of a cleaning device 410 that includes a strainer 412, which is similar to the strainers described above. The strainer 412 includes a base 414 similar to the strainers described above. Accordingly, further description of the strainer 412 and the base 414 are not provided.

Different than the embodiments described above, the cleaning device 410 also includes handles 450 that are movable with respect to the base 414 for moving articles placed into the strainer 412. The handles 450 (two are shown in FIG. 6) include a plurality of teeth 452 that engage cooperating teeth 454 found on a rack 456 that is connected to the base 414. The handles 450 are supported by supports 458 that also support the strainer 412 while allowing the strainer to move in a rotational direction (as shown by FIGURE A) with respect to the supports.

To operate the cleaning device 410 shown in FIG. 6, the operator places objects into the strainer 412 and pushes in and out on the handles 450 in the direction of the arrows B shown in FIG. 6.

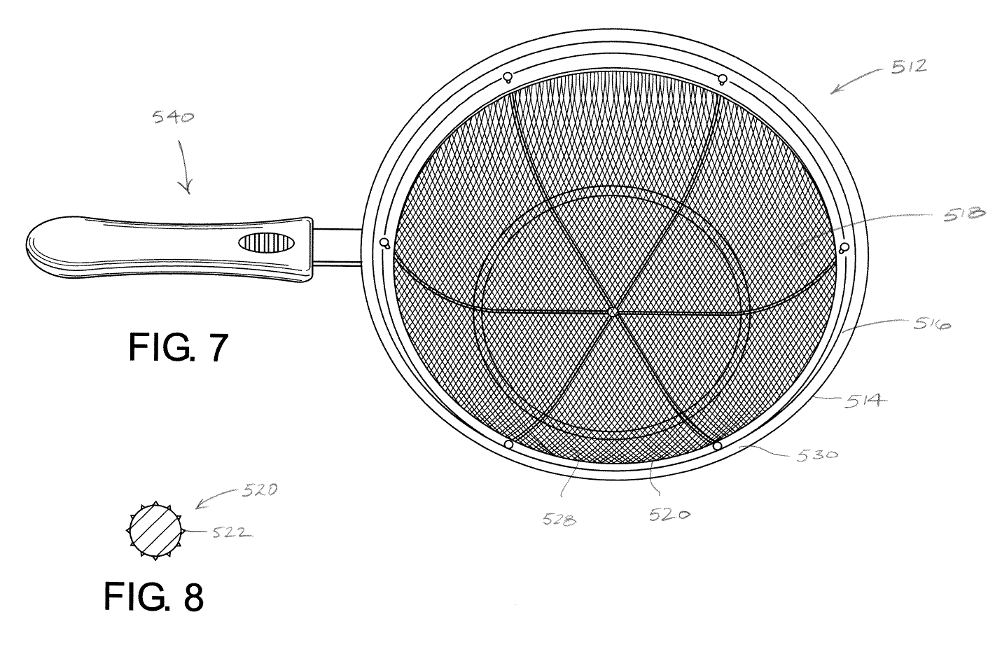

With reference to FIG. 7, an alternative embodiment of a strainer 512 is shown. The strainer 512 in the embodiment depicted in FIG. 7 is similar to a conventional wire strainer or a conventional mesh strainer. The strainer 512 can be made from plastic or metal. The strainer 512 includes a base 514 having an upper open end 516. The strainer 512 also includes an internal surface 518. The strainer 512 also includes a plurality of wires 520 woven together and attached to a circular rim 530, similar to a conventional wire strainer.

With reference to FIG. 8, at least one of the wires 520, and preferably a plurality of wires 520, include a plurality of protrusions 522. The protrusions 522 can be similar to the protrusions 22 shown in FIG. 1. For example, the protrusions 522 can have a similar size and shape to the protrusions 22 described above. Additionally, the density of the protrusions over the internal surface 518 can be similar to the embodiments described above. The protrusions can facilitate the removal of debris from articles place into the strainer 512 similar to the protrusions 522 described above. The protrusions 522 extend radially from a generally circular outer surface of the wire 520. Similar to the embodiments described above, the internal surface 518 of the wire strainer 512 can be coated with coating that includes particles, or has particles added to it, to form the scouring internal surface.

Spacings between the wires 520 can provide openings 528 that extend through the base 514 for allowing liquid to pass through the openings carrying debris from the articles in the strainer. Lids, similar to the lid 80 shown in FIG. 1, can be attached to the strainer 512 and the devices for moving the strainer, for example, the vibration device 50 shown in FIG. 1, the assembly shown in FIG. 5, and the assembly shown in FIG. 6 can also be utilized with the strainer shown in 512. Similar to the embodiments shown above, the strainer 512 can also include a handle 540.

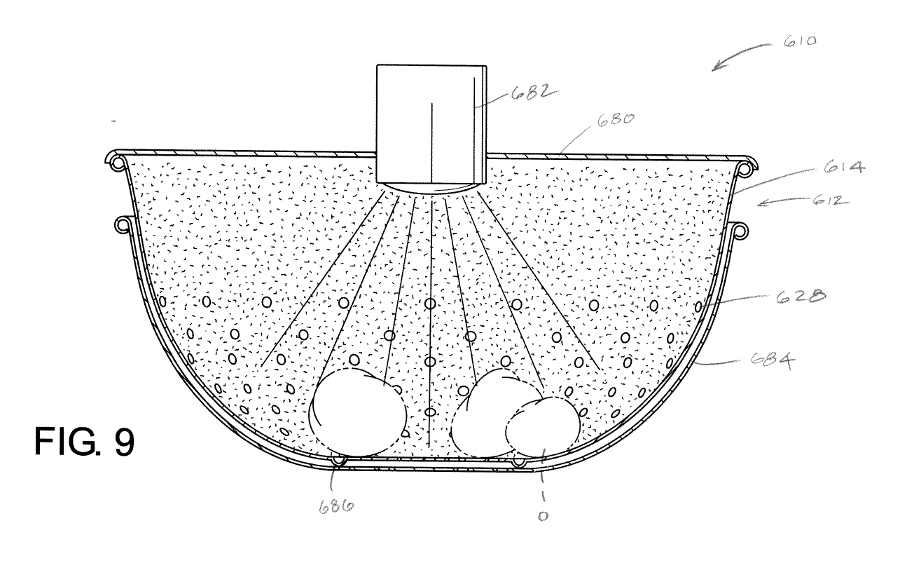

FIG. 9 depicts an alternative embodiment of a cleaning device 610 that includes a strainer 612, which is similar to the strainers described above. Strainer 612 includes a base 614, and since it is similar to the strainers described above, further description of the strainer is not provided.

The cleaning device 610 also includes a lid 680 and a UV light source 682 connected with the lid and configured with respect to the base 614 to direct UV light onto articles O in the strainer 612. The lid 680 is similar to the lids described above, except for that the lid is solid to prevent direct UV light from escaping the strainer 612 and being directed toward an operator of the cleaning device 610. To also avoid exposure to the UV light emanating from the UV light source 682, a base cover 684 is provided around the base 614 of the strainer 612 and extends vertically above an uppermost opening 628 found in the base. Spacers 686 are provided on a lowermost surface of the base and extend outwardly therefrom to space the base cover 684 from the base 614 to allow water to exit the strainer 612 during the cleaning operation.

UV light from the UV light source 682 can be directed onto the objects O in the strainer to destroy bacteria on an outer surface of these objects during the cleaning process.

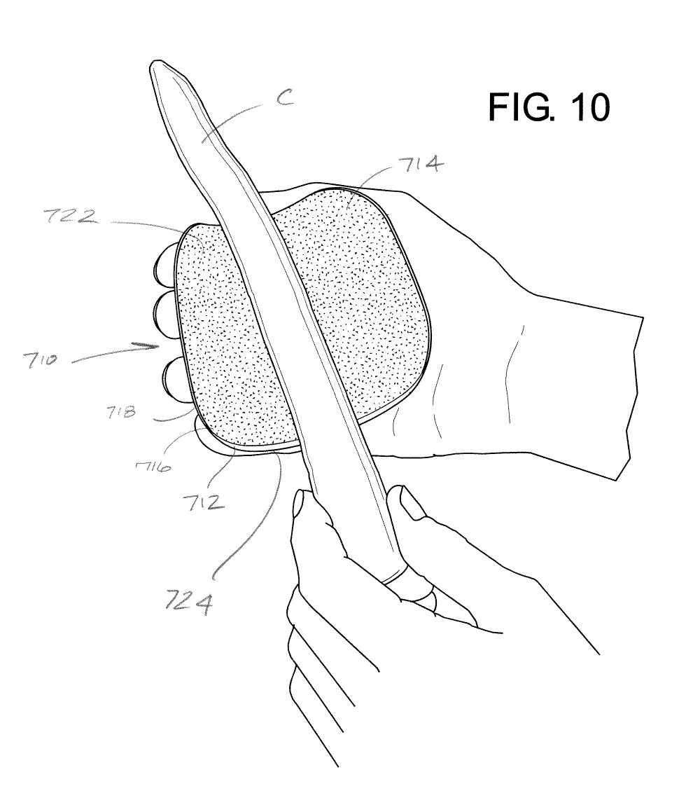

FIG. 10 depicts an alternative embodiment of a cleaning device 710 used to clean a carrot C. For the embodiment depicted in FIG. 10, the cleaning device 710 includes a base 712 and scouring elements 714. The base 712 is made from a generally water-impervious material, e.g. plastic. The base 712 in the depicted embodiment is generally thin and flat and is also made from a flexible material. The base 712 includes a first surface 716 and a second surface 718, which is opposite the first surface. The base 712 and the scouring elements 714 are made from a dishwasher safe material, which allows the cleaning device 710 to be placed in the dishwasher after being used. In the depicted embodiment, the base 712, as well as the entire cleaning device 710, is generally palm-sized. In other words, the base 712 can be generally rectangular having a greatest dimension less than about 12.5 mm. Different than the embodiments described above, the cleaning device 710 is devoid of openings.

The scouring elements 714 are located on the first surface 716 of the base 712 and define a roughened surface 722. Similar to the embodiments described above, the scouring elements 714 are for removing debris from articles that contact the scouring elements. The scouring elements can be protrusions, protuberances and/or bumps (similar to sand paper) that are useful for cleaning the skin of produce or other articles. Similar to the embodiments described above, the scouring elements 714, or protrusions, can extend a height of about 85 micrometers from the first surface 716 of the base 712 to about 640 micrometers from the first surface. The protrusions can have an average diameter of about 85 micrometers to about 640 micrometers. The roughened surface 722 can include from about 30 protrusions per square inch to about 425 protrusions per square inch.

The protrusions can be injection molded with the plastic base 712. Alternatively, the protrusions can be affixed to the base using an adhesive, especially where the protrusions are made from a layered material. The protrusions can also be deposited on the base in a similar manner to the embodiments of cleaning devices described above.

To use the cleaning device 710 depicted in FIG. 10, an operator rubs the scrubbing elements 714 against the moistened skin of a piece of produce. Since the cleaning device 710 is made small enough, e.g. it is palm sized, openings are not necessary to drain the water away while the abrasive protrusions clean the produce, or other object. Where the cleaning device is used mainly to clean produce, the base 712 can include a sharpened edge 724 configured to cut produce.

Cleaning devices, strainers and colanders have been described above with regard to particular embodiments. Modifications and alterations can occur to those skilled in the art after having read and understood the preceding detailed description. The invention is not only limited to those embodiments described above. Instead, the invention is defined by the appended claims and the equivalents thereof.

1. A strainer comprising a base including an upper open end, an internal surface having abrasive scouring elements for removing debris from associated articles placed into the strainer and openings extending through the base for allowing liquid to pass through the openings carrying debris from the associated articles retained in the strainer, with respect to the upper open end at least some of the openings are located vertically below a respective abrasive protrusion.

2. The strainer of claim 1, wherein the base includes a generally smooth base surface and the scouring elements comprise protrusions extending upwardly from the base surface a height less than about 335 micrometers from the base surface.

3. The strainer of claim 1, wherein the base includes a roughened interior surface section, the scouring elements being located in the roughened interior section and the roughened section including at least about 50 scouring elements per square inch.

4. The strainer of claim 3, wherein the scouring elements have an average diameter of less than about 335 micrometers.

5. The strainer of claim 1, wherein at least a portion of the roughened interior surface section is interrupted by a substantially smooth interior surface section that is substantially devoid of scouring elements.

6. The strainer of claim 1, wherein the base and the scouring elements are integrally formed of plastic.

7. The strainer of claim 1, wherein the base is made from metal and the scouring elements are deposited on the base.

8. The strainer of claim 1, wherein the scouring elements are brush-like bristles extending from the base.

9. The strainer of claim 1 in combination with a lid connected to or connectable with the base for covering at least a portion of the upper open end.

10. The combination of claim 9, further comprising a UV light source connected with the lid and configured with respect to the base to direct UV light onto the associated articles in the strainer.

11. The combination of claim 9 wherein the lid is fixed to the upper open end and extends toward the interior of the base.

12. The strainer of claim 1 in combination with a handle connected with and movable with respect to the base for moving the associated articles placed into the base.

13. The combination of claim 12, further comprising a paddle operatively connected with the handle, movement of the handle resulting in movement of the paddle.

14. The combination of claim 12, further comprising a rack connected with the base, wherein the handle cooperates with the rack such that movement of the handle moves the base.

15. The strainer of claim 1 in combination with a vibrating device, the vibrating device being connected with the base.

16. The strainer of claim 1, wherein the base includes a plurality of wires and at least one of the wires includes a radially extending protrusion, which makes up at least a portion of the scouring elements.

17. The strainer of claim 1, wherein the base includes a mesh and a plurality of protrusions, which make up at least a portion of the scouring elements.

18. The strainer of claim 1, wherein the base is made from a flexible material that is collapsible into a storage position.

19. A cleaning device comprising:
a generally water impervious and generally flat flexible base defining a first surface and a second surface; and
scouring elements located on the first surface of the base to define a roughened surface, wherein the roughened surface includes at least about 50 scouring elements per square inch and the scouring elements having an average diameter of less than about 335 micrometers.

20. The cleaning device of claim 19, wherein the base includes a sharpened edge configured to cut produce.

21. The cleaning device of claim 19, wherein the base is generally palm-sized.
